(19) United States
(12) Patent Application Publication
(10) Pub. No.: US 2021/0060713 A1
(43) Pub. Date: Mar. 4, 2021

(54) FLUX

(71) Applicant: SENJU METAL INDUSTRY CO., LTD., Adachi-ku, Tokyo (JP)

(72) Inventors: Tomohisa KAWANAGO, Shimotsuke-shi (JP); Miyuki HIRAOKA, Mooka-shi (JP); Takahiro NISHIZAKI, Campbell (CA); Naokatsu KOJIMA, Mooka-shi (JP); Hiroyoshi KAWASAKI, Tokyo (JP)

(21) Appl. No.: 16/644,362

(22) PCT Filed: Sep. 6, 2018
(86) PCT No.: PCT/JP2018/032958

§ 371 Date: Mar. 4, 2020

(30) Foreign Application Priority Data
Sep. 6, 2017 (JP) 2017-171274

(51) Int. Cl. B23K 35/362

(52) U.S. Cl. CPC B23K 35/362

(57) ABSTRACT

A flux is provided which maintains activity by suppressing formation of an ester due to a reaction between an organic acid and a hydroxy group of an alcohol contained in a solvent and improves solderability.

The flux includes: 40 mass % to 90 mass % of water; 2 mass % to 15 mass % of an organic acid; and greater than 0 mass % and less than or equal to 48 mass % of a solvent having a hydroxy group, in which when a molar mass % of all organic acid carboxyl group unit contained in the organic acid is regarded as 100 unit mol %, the content ratio of all carboxylic acid ester unit esterified by the organic acid and the hydroxy group which is contained in the solvent is 0 unit mol % to 50 unit mol %.

### TECHNICAL FIELD

The present invention relates to a flux containing water.

### BACKGROUND ART

There are various methods for forming solder bumps on a substrate. A method for transferring a flux to solder balls and mounting the solder balls with the flux on electrodes has been adopted in association with the miniaturization of solder balls in recent years. Solder bumps are formed by reflowing a substrate on which the solder balls are mounted and cooling the substrate.

The flux chemically removes metal oxide films present on surfaces of a solder alloy and a metal, which is a joining object to be soldered, and enables movement of metallic elements at the boundary between the two surfaces. For this reason, an intermetallic compound is formed between the surfaces of the solder alloy and the metal which is a joining object by performing soldering using the flux, and firm joining is attained. There is a flux containing an organic acid, a solvent, and the like. An organic acid is added to a flux as an activator component for removing a metal oxide film, and a solvent has a role of dissolving a solid component in a flux. There is a flux containing water. For example, Patent Literature 1 discloses a flux containing 0.1 to 0.4 weight % of water relative to the total amount.

### CITATION LIST

### Patent Literature

[Patent Literature 1] Japanese Unexamined Patent Application, First Publication No. 2005-74449

### SUMMARY OF INVENTION

### Technical Problem

There is a flux in which a large amount of flux residue remains on the premise of washing after soldering. The flux residue leads to a decrease in solderability such as poor joining of solder or poor conductivity. Therefore, in order to construct a composition of a flux that does not require washing or a flux that can be washed with water, attempts have been made to reduce the flux residue. It is possible to design a low-residue flux by substituting a part or all of a base agent, which has poor reactivity with an organic acid and does not easily volatilize during reflowing, with a highly volatile solvent or the like. However, an organic acid gradually reacts with a hydroxy group (—OH group) of an alcohol in a solvent, which is contained in a larger amount than that in conventional, and is easily esterified with change over time from production of a flux to the time of use.

In a case where an organic acid forms an ester, activity of the organic acid which acts on removal of a metal oxide film is deactivated. In a case where the removal of a metal oxide film is insufficient, there is a problem in that a solder alloy cannot be firmly joined to a joining object. Such a problem is not considered at all in the flux disclosed in the above-described Patent Literature 1.

Accordingly, the present invention solves such a problem, and an object of re present invention is to provide a flux which maintains activity by suppressing formation of an ester due to a reaction between an organic acid and a hydroxy group of an alcohol contained in a solvent and improves solderability.

### Solution to Problem

Technical means of the present invention for solving the above-described problem is as follows.

(1) A flux, including: 40 mass % to 90 mass % of water; 2 mass % to 15 mass % of an organic acid; and greater than 0 mass % and less than or equal to 48 mass % of a solvent having a hydroxy group, in which when a molar mass % of an all organic acid carboxyl group units contained in the organic acid is regarded as 100 unit mol %, a content ratio of all carboxylic acid ester units esterified by the organic acid and the hydroxy group which is contained in the solvent is 0 unit mol % to 50 unit mol %, and the organic acid contains at least one of glutaric acid, phenylsuccinic acid, succinic acid, malonic acid, adipic acid, azelaic acid. glycolic acid. diglycolic acid, thioglycolic acid, thiodiglycolic acid, propionic acid, 2,2-bishydroxymethylpropionic acid, 2,2-bishydroxymethylbutanoic acid, malic acid, tartaric acid, and a trimer acid.

The “all organic acid carboxyl group units” in the present invention refers to functional groups of a carboxyl group having activity as an organic acid, the “all carboxylic acid ester units” refers to functional groups in a state in which a carboxyl group is esterified, and “unit mol %” means a molar mass % of each “unit.”

(2) The flux according to (1), in which a content ratio of the water is 40 mass % to 80 mass %.

(3) The flux according to 1 or (2), in which a content ratio of the solvent is 8 mass % to 48 mass %.

(4) The flux according to any one of (1) to (3), further including: greater than 0 mass % and less than or equal to 10 mass % of an amine, in which the amine contains at least one of imidazole compounds, an aliphatic amine, an aromatic amine, an amino alcohol, a polyoxyalkylene-type alkylamine, a terminal amine polyoxyalkylene, and an amine hydrohalide.

### Advantageous Effects of invention

Hydrolysis occurs in the flux of the present invention due to water contained therein. Therefore, it is possible to suppress formation of an ester due to a reaction between an organic acid and a hydroxy group contained in a solvent. For this reason, a metal oxide film can be sufficiently removed. In addition, the solderability is favorable.

### DESCRIPTION OF EMBODIMENTS

Hereinafter, a flux of an embodiment of the present invention will he described. The flux of the present embodiment contains 40 mass % to 90 mass % of water; 2 mass % to 15 mass % of an organic acid; and greater than 0 mass % and less than or equal to 48 mass % of a solvent having a hydroxy group. Pure water can be used as the water, and the content ratio of the water is more preferably 40 mass % to 80 mass %. The content ratio of the solvent is more preferably 8 mass % to 48 mass %.

A water-soluble organic acid is preferably used as the organic acid and is added as an activator component in the flux. Metal oxides present on surfaces of a solder alloy and a metal, which is a joining object to be soldered, are chemically removed using this activator component during soldering. At least one of glutaric acid, phenylsuccinic acid, succinic acid, malonic acid, adipic acid, azelaic acid, glycolic acid, diglycolic acid, thioglycolic acid, thiodiglycolic acid, propionic acid, 2,2-bishydroxymethylpropionic acid, 2,2-bishydroxymethylbutanoic acid, malic acid, tartaric acid, a dimer acid, a hydrogenated dimer acid, and a trimer acid is used as the organic acid. These organic acids have a carboxyl group. As an example of an organic acid, a monofunctional organic acid has one carboxyl group and is represented by the following chemical formula.

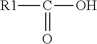

In the formula, R1 represents a linear or branched alkyl group, alkyl ether group, or the like. In addition, R1 may include an aromatic ring. A bifunctional organic acid has two carboxyl groups, and a tri- or higher functional organic acid has three or more carboxyl groups. A greater number of functional group moles of carboxyl groups having activity as organic acids (hereinafter referred to as “organic acid carboxyl group units”) in a flux leads to stronger activity on removal of a metal oxide film. For example, relative to 1 mol of an organic acid, a monofunctional organic acid has 1 mol of an organic acid carboxyl group unit, a bifunctional organic acid has 2 mol of an organic acid carboxyl group unit, and a trifunctional organic acid has 3 mol of an organic acid carboxyl group unit.

A solvent having a hydroxy group is used as the solvent. The solvent preferably has water solubility and preferably does not volatilize in a low-temperature range of 120° C. to 150° C. in order to efficiently cause action of an activator. In a case where a solvent volatilizes, a flux is dried and hardened. Therefore, it is difficult for the flux to be wet-spread to a joining spot. For this reason, the boiling point of the solvent is preferably higher than or equal to 200° C. In addition, a solvent volatilizing at a reflow temperature is preferably used, and the boiling point of the solvent is preferably lower than or equal to 280° C. At least one of 1,3-propanediol, hexylene hexyl diglycol, 1,3-butanediol, 2-ethyl-1,3-hexanediol, 2-ethylhexyl diglycol, phenyl glycol, butyl triglycol, and terpineol is preferably used as the solvent. These solvents are represented by the following chemical formula.

R2-OH

In the formula, R2 represents a linear or branched alkyl group, alkyl ether group, or the like. In addition, R2 may include an aromatic ring.

The flux of the present embodiment may contain, for example, at least one of amines such as imidazole compounds, an aliphatic amine, an aromatic amine, an amino alcohol, a polyoxyalkylene-type alkylamine, a terminal amine polyoxyalkylene, and an amine hydrohalide to be described below. An amine is added as an activity auxiliary component in the flux. When an amine reacts with an organic acid, the amine forms a salt, and increases the heat resistance. In a case where a large amount of an amine is added to a flux, the amount of flux residue increases. Therefore, the flux preferably contains 0 mass % to 10 mass % of an amine. The amine of the present embodiment preferably an amine having a molecular weight of less than or equal to 700, and is more preferably an amine having a molecular weight of less than or equal to 600.

Examples of imidazole compounds include imidazole, 2-methvlimidazole, 2-ethyl-4-methylimidazole, and 1-benzyl-2-phenylimidazole. Examples of aliphatic amines include methyl amine, ethylamine, dimethylamine, 1-aminopropane, isopropylamine, trimethylamine, n-ethylmethylamine, allylamine, n-butylamine, diethylamine, sec-hutylamine, tert-butylamine, N,N-dimethylethylamine, isobutylamine, pyrrolidine, 3-pyrroline, n-pentylamine, dimethylaminopropane, 1-aminohexane, triethylamine, diisopropylamine, dipropyla.mine, hexamethyleneimine, 1-methylpiperidine, 2-methylpiperidine, 4-methylpiperidine, cyclohexylamine, diallylamine, n-octylamine, aminomethyl, cyclohexane, n-octylamine, 2-ethylhexylamine, dibutylamine, diisobutylamine, 1,1,3,3-tetramethylbutylamine, 1-cyclohexylethylamine, and N,N-dimethylcyclohexylamine. Examples of aromatic amines include aniline, diethylaniline, pyridine, diphenylguanidine, and ditolylguanidine. Examples of amino alcohols include 2-ethylaminoethanol, diethanolamine, diisopropanolamine, N-butyldiethanolamine, triisopropanolamine, N,N-bis(2-hydroxyethyl)-N-cyclohexylamine, triethanolamine, N,N,N,N′,N′-tetrakis(2-hydroxypropyl) ethylenediamine, and N,N,N′N″,N″-pentakis(2-hydroxypropyl) diethylenetriamine. Examples of polyoxyalkylene-type alkylamines include polyoxyalkylene alkylamines, polyoxyalkylene ethylenediamines, and polyoxyalkylene diethylenetriamines. Examples of terminal amine polyoxyalkylenes include a terminal amino polyethylene glycol-polypropylene glycol copolymer (a terminal amino PEG-PPG copolymer). Examples of amine hydrohalides, which are hydrohalides of the above-described various amines (such as a hydrofluoric acid salt, a hydrofluoroboric acid salt, hydrochloride, hydrobromide, and hydroiodide), include ethylamine hydrochloride, ethylamine hydrobromide, cyclohexylamine hydrochloride, and cyclohexylamine hydrobromide.

The flux of the present embodiment may contain, for example, at least one halogen compound of trans-2,3-dibromo-2-butene- ,4-diol, 2,3-dibromo-1,4-butanediol, 2,3-dibromo-1-propanol, 2,3-dichloro-1-propanol, 2,2,2-tribromoethanol, and 1,1,2,2-tetrabromoethane within a range not impairing the performance of the flux.

The flux of the present embodiment may contain, for example, at least one surfactant among polyoxyethylene ethylenediamines, polyoxypropylene ethylenediamines, polyoxyethylene polyoxypropylene ethylenediamines, polyoxyethylene alkylamines, polyoxyethylene tallow amine, polyoxyethylene alkylpropyldiamines, polyoxyethylene tallow propyldiamine, polyoxyethylene alkyl ethers, polyoxyethylene alkyl amides, and an aliphatic alcohol ethylene oxide adduct within a range not impairing the performance of the flux. Surfactants adjust the surface tension of a flux. The surfactants of the present embodiment preferably have a molecular weight of greater than 700.

Furthermore, a colorant such as a coloring agent, pigment, or dye, an anti-foaming agent, a thixotropic agent, or the like may be appropriately added to the flux of the present embodiment within a range not impairing the performance of the flux.

In a case where an organic acid reacts with a hydroxy group contained in a solvent, an esterified organic acid ester in which the organic acid is esterified is formed to generate water. The reaction between the organic acid and the hydroxy group in the solvent is represented by the following reaction formula (1) when the reaction is described using a monofunctional organic acid as an example of the organic acid and a monofunctional alcohol as an example of the solvent. Since a reaction occurs between a hydroxy group and each carboxyl group, the description of reactions between a bifunctional organic acid or a tri- or higher functional organic acid and a bifunctional alcohol or a tri- or higher functional alcohol will not be repeated.

R1COOH+R2OH→R1COOR2+H₂O (1)

An organic acid ester (R1COOR2) does not have metal oxide film-removing activity, which an organic acid has, as a flux. For this reason, the flux containing an organic acid and a solvent having a hydroxy group sometimes loses its metal oxide film-removing activity as a flux.

The esterification reaction of the reaction formula (1) is a reversible equilibrium reaction, and hydrolysis shown in the following reaction formula (2) also occurs in an environment where an organic acid ester and water coexist.

R1COOR2+H₂O R1COOH+R2OH (2)

That is, in a case where an organic acid is mixed with a solvent having a hydroxy group in a flux, both reactions of the reaction formulae (1) and (2) occur, and the reactions enter an equilibrium state where the reaction rates thereof are the same as each other after the lapse of a predetermined time.

Here, the number of moles of a functional group unit obtained by esterification of an organic acid when the reactions of the reaction formulae (1) and (2) enter an equilibrium state will be described. A greater number of moles of all organic acid carboxyl group units leads to stronger activity of an organic acid. A smaller number of moles of all organic acid carboxyl group units leads to weaker activity of an organic acid.

First, a reaction in which a monofunctional organic acid is esterified is shown in a reaction formula (3). In a case where the organic acid reacts with a hydroxy group, a dehydration reaction occurs to form an organic acid ester as shown in the reaction formula (1). Hereinafter, functional groups in a state in which a carboxyl group is esterified is referred to as “carboxylic acid ester units,” and the functional group molar mass % is referred to as “unit mol %.”

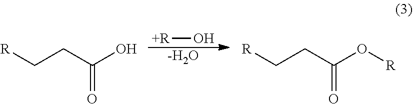

When the reactions of the reaction formulae (1) and (2) are in an equilibrium state and the numbers of moles of an organic acid and an organic acid ester present in a flux are the same as each other, if the total of the organic acid and the organic acid ester is regarded as 100 mol %, the content ratio of the organic acid is 50 mol % and the content ratio of the organic acid ester is 50 mol %. There is one carboxyl group in one organic acid and one ester group in one organic acid ester. Therefore, when the content of all organic acid carboxyl group units of the organic acid put into the flux is regarded as 100 unit mol %, the content ratio of all the organic acid carboxyl group units is 50 unit moi% and the content ratio of all the carboxylic acid ester units is 50 unit mol %. That is, the values of the unit mol % of all the carboxyl group and the unit mol % of all the ester group are the same as each other.

Next, a reaction in which a bifunctional organic acid is esterified is shown in a reaction formula (4).

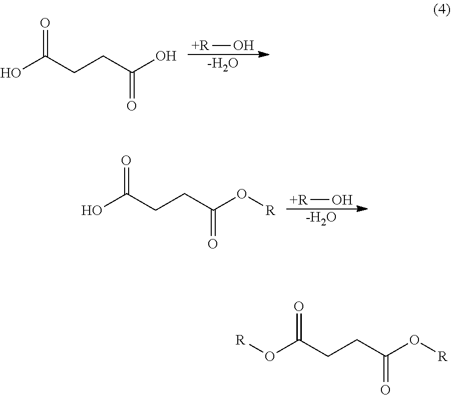

When the bifunctional organic acid shown on the leftmost side of the reaction formula (4) is esterified, an organic acid monoester which is shown at the center of the reaction formula (4) and in which one of the two carboxyl groups is esterified is first formed. In a case where the esterification further proceeds, an organic acid diester which is shown on the rightmost side of the reaction formula (4) and in which the two carboxyl groups are esterified is formed.

In a case where the reactions reach an quilibrium state and the organic acid monoester is formed, when the numbers of moles of an organic acid and an organic acid monoester in a flux are the same as each other, if the total of the organic acid and the organic acid monoester is regarded as 100 mol %, the content ratio of the organic acid is 50 mol % and the content ratio of the organic acid monoester is 50 mol %. There are two carboxyl groups in one organic acid, and there is one carboxyl group and one ester group in one organic acid monoester. Therefore, the ratio of all the organic acid carboxyl group units to all the carboxylic acid ester units is 3:1. Accordingly, when the content of all organic acid carboxyl group units of the organic acid put into the flux is regarded as 100 unit mol %, the content ratio of all the organic acid carboxyl group units is 75 unit mol % and the content ratio of all the carboxylic acid ester units is 25 unit mol %.

In a case where the reactions reach an equilibrium state and an organic acid diester is formed, there are two carboxyl groups in an organic acid and two ester groups in an organic acid diester. Therefore, in a case where the same numbers of organic acids and organic acid diesters are present, the ratio of all the organic acid carboxyl group units to all the carboxylic acid ester units becomes 1:1. In a case where the content of all organic acid carboxyl group units of the organic acid put into the flux is regarded as 100 unit mol %, the content ratio of all the carboxyl group units is 50 unit mol % and the content ratio of all the carboxylic acid ester units becomes 50 unit mol %.

When the content of all organic acid carboxyl group units of the organic acid put into the flux is regarded as 100 unit mol %, if the content ratio of all the carboxylic acid ester units is 0 unit mol % to 50 unit mol %, all the organic acid carboxyl group unit are present in a content ratio of 50 mol % to 100 mol %. Therefore, there are sufficient activities of an organic acid.

Next, the relationship between the concentration of an orgranic acid and the concentration of an organic acid ester when the reactions of the reaction formulae (1) and (2) enter an equilibrium state will be described. In a case where the types of organic acid and solvent and the flux temperature are fixed, the ester concentration in the flux is determined by the following equilibrium constant equation (5).

$$K 1 = \frac{[ R 1 COOR 2 ] [ {H}_{2} O ]}{[ R 1 COOH ] [ R 2 OH ]} \\ K 1 \text{:} Equilibrium constant \qquad ( 5 )$$

[R1COOR2]: Concentration of organic acid ester

[H₂O]: Concentration of water

[R1COOH]: Concentration of organic acid

[R2OH]: Concentration of alcohol

Here, since alcohols are excessively present in a solvent, it may be assumed that there is no change in the equilibrium constant. For this reason, the equilibrium constant equation (5) can be approximated to an equilibrium constant equation (6).

$$K 2 = \frac{[ R 1 COOR 2 ] [ {H}_{2} O ]}{[ R 1 COOH ]} \\ K 2 \text{:} Equilibrium constant \qquad ( 6 )$$

Referring to the equilibrium constant equation (6), since the equilibrium constant is kept a constant value, it is considered possible to promote the reaction of the reaction formula (2) by increasing the concentration of water [H₂O] and to increase the concentration of a non-esterified organic acid [R1COOH]. On the other hand, in a case where the flux contains a large amount of water, if heated water bumps during reflowing, a state (ball missing) in which solder deviates from an electrode occurs. Such ball missing causes poor joining of solder or poor conductivity. The present inventors prepared fluxes of each example and comparative example with each composition shown in Tables 1 and 2 in order to limit the formation of an ester and to determine the proportion of the composition contained in the flux that improves solderability, and conducted esterification suppression verification and ball missing suppression verification on each flux as follows.

### EXAMPLES

Hereinafter, specific examples of the flux according to the present invention will be shown with reference to the examples, but the present invention is not limited to the following specific examples. In addition, the units of the numerical values without any unit are mass % in the following tables.

(I) Regarding Esterification Suppression Verification

(A) Evaluation Method

The acid value of each flux of the examples and the comparative examples was measured according to JIS K0070 using potassium hydroxide. After storing each flux for four weeks at 40° C., the acid value of each flux was measured. The reduction rate of the acid value of each flux was calculated.

(B) Determination Criteria

B: The reduction rate of the acid value was within 50%.

C: The reduction rate of the acid value exceeded 50%.

The acid value refers to the number of milligrams of potassium hydroxide necessary for neutralizing acids contained in 1 g of a flux. The higher the acid value in a flux, the larger the number of moles of all organic acid carboxyl group units in the flux becomes, and the lower the acid value in the flux, the smaller the number of moles of all the organic acid carboxyl group units in the flux becomes.

That is, in a case where an organic acid reacts with a hydroxy group contained in a solvent to form an organic acid ester, the number of moles of all the organic acid carboxyl group units in the flux decreases. Therefore, the acid value decreases. For this reason, it can be said that the higher the reduction rate of the acid value after four weeks in the flux, the higher the esterification rate of the organic acid in the flux becomes, and the lower the reduction rate of the acid value in the flux, the more the esterification of the organic acid in the flux is suppressed.

In the case where the organic acid is esterified, the activity of removing a metal oxide film is lost. The flux in which the esterification of the organic acid is suppressed can sufficiently remove a metal oxide film present on the surface of metal, and therefore, a solder alloy can be firmly joined to an object to be joined. It can be said that, when the content of all organic acid carboxyl group units put into the flux is regarded as 100 unit mol % in a flux in which the reduction rate of an acid value is within 50%, the content ratio of all esterified carboxylic acid ester units is 0 unit mol % to 50 mol %, and that the flux has a sufficient property of removing a metal oxide film which an organic acid has. For this reason, the present inventors have found that the flux in which the reduction rate of an acid value is within 50% is a flux that can suppress the esterification of an organic acid.

(II) Regarding Ball Missing Suppression Verification

In the ball missing suppression verification, two kinds of verification under the following conditions 1 and 2 were conducted on the fluxes of each of the examples and comparative examples.

(A) Evaluation Method: Condition 1

Solder balls which have a composition of Sn-3Ag-0.5Cu and have a diameter of 600 μm were prepared. The prepared solder balls were respectively coated with the fluxes of the examples and the comparative examples. Then, each of the solder balls coated with each flux was mounted on an electrode of a substrate. Then, the substrate was heated at a setting of 100° C. for 1 minute using a high-speed heater, and was then heated at 250° C. for 5 seconds. Thereafter, the substrate was cooled at room temperature. The state of the electrode after the substrate was cooled at room temperature was visually checked.

(B) Evaluation Method: Condition 2

Solder balls which have a composition of Sn-3Ag-0.5Cu and have a diameter of 600 μm were prepared. The prepared solder balls were respectively coated with the fluxes of the examples and the comparative examples. Then, each of the solder balls coated with each flux was mounted on an electrode of a substrate. Then, the substrate was heated at a setting of 110° C. for 1 minute using a high-speed heater, and was then heated at 250° C. for 5 seconds. Thereafter, the substrate was cooled at room temperature. The state of the electrode after the substrate was cooled at room temperature was visually checked.

(C) Determination Criteria

A: Solder remained without deviating from an electrode in the verification under conditions 1 and 2.

B: Solder remained without deviating from an electrode in the verification under condition 1.

C: Ball missing occurred due to solder deviating from an electrode in the verification under conditions 1 and 2.

Ball missing causes poor joining of solder or poor conductivity. In a case where solder remains on an electrode after heating, a solder bump in which poor joining or poor conductivity is suppressed can be formed. The temperature condition in condition 2 is more severe than that in the condition 1. Therefore, it is possible to determine that a flux in which there was no ball missing observed in the verification under condition 1 is a flux having sufficiently favorable solderability. It is determined that a flux in which there is no ball missing observed in the verification under conditions 1 and 2 is a flux having more favorable solderability.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Water | Pure water | 40 | 40 | 50 | 50 | 60 | 70 | 80 | 90 | 40 |
| Organic | Malonic acid | | | 2 | | 2 | 2 | 2 | 2 | |
| acid | Malic acid | 15 | 15 | | 2 | | | | | 15 |
| Amine | Imidazole | | 10 | | | | | | | 1 |
| Solvent | 1,3-Propanediol | 45 | 35 | 48 | 48 | 38 | 28 | 18 | 8 | 44 |

| | | | | | | | | | |
|---|---|---|---|---|---|---|---|---|---|
| Total | 100 | 100 | 100 | 100 | 100 | 100 | 100 | 100 | 100 |
| Esterification suppression | B | B | B | B | B | B | B | B | B |
| Ball mixing | A | A | A | A | A | A | A | B | A |

TABLE 2

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | | Example 1 | Example 2 | Example 3 | Example 4 | Example 5 | Example 6 | Example 7 | Example 8 | Example 9 |
| Water | Pure water | 0 | 0 | 0.1 | 5 | 10 | 10 | 20 | 30 | 98 |
| Organic | Malonic acid | 2 | | 2 | 2 | 2 | | 2 | 2 | 2 |
| acid | Malic acid | | 5 | | | | 2 | | | |
| Amine | Imidazole | | 1 | | | | | | | |
| Solvent | 1,3-Propanediol | 98 | 94 | 97.9 | 93 | 88 | 88 | 78 | 68 | 0 |

| | | | | | | | | | |
|---|---|---|---|---|---|---|---|---|---|
| Total | 100 | 100 | 100 | 100 | 100 | 100 | 100 | 100 | 100 |
| Esterification suppression | C | C | C | C | C | C | C | C | — |
| Ball mixing | A | A | A | A | A | A | A | A | C |

The flux of Example 1 contained 40 mass % of pure water, 15 mass % of malic acid as an organic acid, and 45 mass % of 1,3-propanediol as a solvent. In the flux of Example 1, it was possible to suppress esterification and ball missing did not occur under conditions 1 and 2.

The flux of Example 2 contained 40 mass % of pure water, 15 mass % of malic acid, 10 mass % of imidazole as an amine, and 35 mass % of 1,3-propanediol. In the flux of Example 2, it was possible to suppress esterification and ball missing did not occur under conditions 1 and 2.

The flux of Example 3 contained 50 mass % of pure water, 2 mass % of malonic acid as an organic acid, and 48 mass % of 1,3-propanediol. In the flux of Example 3, it was possible to suppress esterification and ball missing did not occur under conditions 1 and 2.

The flux of Example 4 contained 50 mass % of pure water, 2 mass % of malic acid, and 48 mass % of 1,3-propanediol. In the flux of Example 4, it was possible to suppress esterification and ball missing did not occur under conditions 1 and 2.

The flux of Example 5 contained 60 mass % of pure water, 2 mass % of mimic acid, and 38 mass % of 1,3-propanediol. In the flux of Example 5, it was possible to suppress esterification and ball missing did not occur under conditions 1 and 2.

The flux of Example 6 contained 70 mass % of pure water, 2 mass % of malonic acid, and 28 mass % of 1,3-propanediol. In the flux of Example 6, it was possible to suppress esterification and ball missing did not occur under conditions 1 and 2.

The flux of Example 7 contained 80 mass % of pure water, 2 mass % of malonic acid, and 18 mass % of 1,3-propanediol. In the flux of Example 7. it was possible to suppress esterification and ball missing did not occur under conditions 1 and 2.

The flux of Example 8 contained 90 mass % of pure water, 2 mass % of malonic acid, and 8 mass % of 1,3-propanediol. In the flux of Example 8, it was possible to suppress esterification and ball missing did not occur under condition 1.

The flux of Example 9 contained 40 mass % of pure water, 15 mass % of malic acid, 1 mass % of imidazole, and 44 mass % of 1,3-propanediol. In the flux of Example 9, it was possible to suppress esterification and ball missing did not occur under conditions 1 and 2.

The flux of Comparative Example 1 did not contain pure water, but contained 2 mass % of malonic acid and 98 mass % of 1,3-propanediol. In the flux of Comparative Example 1, ball missing did not occur under conditions 1 and 2, but the reduction rate of an acid value exceeded 50%. Therefore, esterification was not sufficiently suppressed.

The flux of Comparative Example 2 did not contain pure water, but contained 5 mass % of malic acid, 1 mass % of imidazole, and 94 mass % of 1,3-propanediol. In the flux of Comparative Example 2, ball missing did not occur under conditions 1 and 2, but the reduction rate of an acid value exceeded 50%. Therefore, esterification was not sufficiently suppressed.

The flux of Comparative Example 3 contained 0.1 mass % of pure water, 2 mass % of malonic acid, and 97.9 mass % of 1,3-propanediol. In the flux of Comparative Example 3, ball missing did not occur under conditions 1 and 2, but the reduction rate of an acid value exceeded 50%. Therefore, esterification was not sufficiently suppressed.

The flux of Comparative Example 4 contained 5 mass % of pure water, 2 mass % of malonic acid, and 93 mass % of 1,3-propanediol. Ball missing did not occur under conditions 1 and 2, but the reduction rate of an acid value exceeded 50%. Therefore, esterification was not sufficiently suppressed.

The flux of Comparative Example 5 contained 10 mass % of pure water, 2 mass % of malonic acid, and 88 mass % of 1,3-propanediol. In the flux of Comparative Example 5, ball missing did not occur under conditions 1 and 2, but the reduction rate of an acid value exceeded 50%. Therefore, esterification was not sufficiently suppressed.

The flux of Comparative Example 6 contained 10 mass % of pure water, 2 mass % of malic acid, and 88 mass % of 1,3-propanediol. In the flux of Comparative Example 6, hall missing did not occur under conditions 1 and 2, but the reduction rate of an acid value exceeded 50%. Therefore, esterification was not sufficiently suppressed.

The flux of Comparative Example 7 contained 20 mass % of pure water, 2 mass % of malonic acid, and 78 mass % of 1,3-propanediol. In the flux of Comparative Example 7, ball missing did not occur under conditions 1 and 2, but the reduction rate of an acid value exceeded 50%. Therefore, esterification was not sufficiently suppressed.

The flux of Comparative Example 8 contained 30 mass % of pure water, 2 mass % of malonic acid, and 68 mass % of 1,3-propanediol. In the flux of Comparative xample 8, ball missing did not occur under conditions 1 and 2, but the reduction rate of an acid value exceeded 50%. Therefore, esterification was not sufficiently suppressed.

The flux of Comparative Example 9 contained 98 mass % of pure water and 2 mass % of malonic acid. In the flux of Comparative Example 9, ball missing occurred under conditions 1 and 2. The flux of Comparative Example 9 contained no solvent, and therefore, the organic acid was not esterified.

The components contained in the fluxes in Examples 7 and 8 and Comparative Example 9 are the same as each other. However, ball missing did not occur under conditions 1 and 2 in Example 7, and under condition 1 in Example 8, hut occurred aider conditions 1 and 2 in Comparative Example 9. It can be said that this is because the ratios of water contained in the fluxes of Examples 7 and 8 and Comparative Example 9 are different from each other and the high content ratio of water causes ball missing. From these results, it can be said that the content ratio of water is preferably less than or equal to 90 mass % and is more preferably less than or equal to 80 mass %.

It was possible to suppress esterification in the flux of Example 1 in which the content ratio of water was 40 mass %. However, the reduction rate of an acid value in the flux of Comparative Example 8 in which the content ratio of water was 30 mass % exceeded 50%. Therefore, the esterification of the flux cannot be sufficiently suppressed. From the results of Example 1 and Comparative Example 8, it can be said that if the content ratio of water is low, the esterification is not sufficiently suppressed. The content ratio of water is preferably greater than or equal to 40 mass %. It can be said that the higher the content ratio of water, the greater the suppression of esterification of an organic acid.

All the fluxes of Examples 1 to 9 contain 40 mass % to 90 mass % of water. In all of the examples, it was possible to suppress esterification and ball missing did not occur under condition 1 as well. Accordingly, it can be said that the content ratio of water is preferably 40 mass % to 90 mass %. Furthermore, ball missing did not occur even under condition 2 in the fluxes of Examples 1 to 7 and 9 having a content ratio of water of 40 mass % to 80 mass %. For this reason, it can be said that the content ratio of water is more preferably 40 mass % to 80 mass %. Although each verification was performed using pure water in the present examples, the same results were obtained using various kinds of pure water such as distilled water or ion-exchanged water.

A flux in the related art contains water so that the amount of water in the flux becomes as small as possible. This is because, as described above, in the case where a. flux contains a large amount of water, if the water is heated and bumps, solder deviates from an electrode, which leads to ball missing and causes poor joining of the solder or poor conductivity, In the fluxes of the present examples, it was possible to suppress ball missing even if the fluxes contain 40 mass % to 90 mass % of water, which is a larger amount compared to the fluxes in the related art. It is considered that this is because the water in the fluxes is used for decomposing an organic acid ester as shown in the reaction formula (2).

The fluxes of Examples 1 to 9 contained 2 mass % to 15 mass % of an organic acid. In all of the examples, esterification was suppressed and ball missing did not occur under condition 1. For this reason, it can be said that the content ratio of an organic acid is preferably 2 mass % to 15 mass %.

Organic acids used in Examples 1 and 4 were different from those used in other examples. However, favorable results were obtained from all the organic acids in all kinds of verification. In addition, favorable results were obtained from the fluxes containing 2 mass % to 15 mass % of the organic acids described in paragraph [0016] of the present specification in the esterification suppression verification and the ball missing suppression verification. Therefore, it can be said that all the organic acids can be preferably used.

The fluxes in Examples 2 and 9 respectively contained 10 mass % and 1 mass % of imidazole, and favorable results were obtained in the esterification suppression verification and the ball missing suppression verification. Accordingly, it can be said that, even though the fluxes contained imidazole in an amount of greater than 0 mass % and less than or equal to 10 mass %, favorable results were obtained in the esterification suppression verification and the ball missing suppression verification.

Although imidazole was used as an amine in the present examples, any amine can be used. In addition, favorable results were obtained from the fluxes containing greater than 0 mass % and less than or equal to 10 mass % of an amine described, for example, in paragraph [0021] of the present specification in the esterification suppression verification and the ball missing suppression verification.

All the fluxes of Examples 1 to 9 contained 8 mass % to 48 mass % of a solvent. Although not shown in the table, even though the content ratio of a solvent in each of the examples was set to be greater than 0 mass % and less than or equal to 48 mass %, favorable results were obtained in the esterification suppression verification and the ball missing suppression verification. From these results, it can be said that the content ratio of a solvent is preferably greater than 0 mass % and less than or equal to 48 mass % and is more preferably 8 mass % to 48 mass %. Although 1,3-propanediol was used as the solvent of the present examples, the type of solvent is not limited thereto. Favorable results were obtained in the esterification suppression verification and the ball missing suppression verification even by using the solvents described in paragraph [0018] of the present specification.

In the present examples, the content ratio of each composition is not limited to the ratios described above. In addition to the above-described examples, favorable results were obtained even from fluxes containing any or a combination of the surfactants described in paragraph [0023], the halogen compounds described in paragraph [0022], the colorant such as a coloring agent, pigment, or dye, and the anti-foaming agent of the present specification within a range not impairing the performance of the fluxes in the esterification suppression verification and the ball missing suppression verification.

The state of an electrode of each substrate was visually checked after the above-described ball missing suppression verification. As a result, the electrodes of the substrates applied with each of the fluxes of the examples had little flux residue, and it was unnecessary to wash the electrodes. In addition, even if there is a residue remaining, it was possible to wash it with water. For this reason, it can be said that the fluxes of the examples are fluxes having favorable solderability.

In the present examples, the content ratio of water was increased compared to the related art and an organic acid ester was hydrolyzed to suppress the esterification of an organic acid. However, the present invention is not limited thereto. Referring to the concentration equation (4), it is considered that the concentration of an organic acid [R1COOH] can be increased by increasing the concentration of an organic acid ester [R1COOR2]. For this reason, the esterification of an organic acid may be suppressed by forming an organic acid ester in advance and adding the formed organic acid ester to the fluxes of the present examples. An ester compound produced from an organic acid and a solvent to be added is preferable as the organic acid ester to be added.

In the present embodiment, the ball missing suppression verification was performed using solder balls, but the present invention is not limited thereto. The above-described fluxes from which favorable results were obtained in the esterification suppression verification and the ball missing suppression verification were used for mounting core balls or metal core columns, which have metal as a core, on a substrate. As a result, it was possible to stably mount both the core balls and the metal core columns and to form a solder bump at a desired position.

1. A flux, comprising:
40 mass % to 90 mass % of water;
2 mass % to 15 mass % of an organic acid; and
greater than 0 mass % and less than or equal to 48 mass % of a solvent having a hydroxy group,
wherein, when a molar mass % of all organic acid carboxyl group units contained in the organic acid is regarded as 100 unit mol %, a content ratio of all carboxylic acid ester units esterified by the organic acid and the hydroxy group which is contained in the solvent is 0 unit mol % to 50 unit mol %, and
wherein the organic acid contains at least one of glutaric acid, phenylsuccinic acid, succinic acid, malonic acid, adipic acid, azelaic acid, glycolic acid, diglycolic acid, thioglycolic acid, thiodiglycolic acid, propionic acid, 2,2-bishydroxymethylpropionic acid, 2,2-bishydroxymethylbutanoic acid, malic acid, tartaric acid, and a trimer acid.

2. The flux according to claim 1,
wherein a content ratio of the water is 40 mass % to 80 mass %.

3. The flux according to claim 1,
wherein a content ratio of the solvent is 8 mass % to 48 mass %.

4. The flux according to claim 1, further comprising:
greater than 0 mass % and less than or equal to 10 mass % of an amine,
wherein the amine contains at least one of imidazole compounds, an aliphatic amine, an aromatic amine, an amino alcohol, a polyoxyalkylene-type alkylamine, a terminal amine polyoxyalkylene, and an amine hydrohalide.
